(19) United States
(12) Patent Application Publication
(10) Pub. No.: US 2007/0095250 A1
(43) Pub. Date: May 3, 2007

(54) Ink Compositions and Methods for Improving Neutrality, Hue Angle and/or Media Independence

(76) Inventors: Linda C. Uhlir-Tsang, Corvallis, OR (US); Hiang P. Lauw, Corvallis, OR (US); Joseph W. Tsang, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/553,932

(22) Filed: Oct. 27, 2006

Related U.S. Application Data
(63) Continuation-in-part of application No. 11/261,345, filed on Oct. 28, 2005.

(51) Int. Cl. C09D 11/00

(52) U.S. Cl. 106/31.27; 106/31.6; 106/31.43; 106/31.75; 106/31.47; 106/31.49; 106/31.77; 106/31.78

(57) ABSTRACT

An ink relating to an ink composition comprising: an ink vehicle; a colorant; and an additive effective to improve media independence of hue and chroma produced with said colorant.

### RELATED APPLICATION

The present application is a continuation-in-part and claims the priority under 35 U.S.C. § 120 of previous U.S. patent application Ser. No. 11/261,345, filed Oct. 28, 2005, entitled “Ink Compositions and Methods for Controlling Color on a Print Medium,” which application is hereby incorporated by reference in its entirety.

### BACKGROUND

Ink-jet printing is a printing process where droplets of ink are deposited on a print medium to form alphanumeric characters, area-fills, images, and other patterns. The ink must be able to provide printed images having good color characteristics, such as the correct hue and high chroma.

While the formation of colors on plain paper is required for inks, the inks should also be able to be used on other print media or conditions such as specialty media, including transparency film, coated paper, and photo paper. While effective printing on some of these media may be met by suitable ink vehicle design, other print conditions must be met by the proper selection and combination of the colorants used in the inks. The selection of the colorants becomes even more important when additional limitations are placed on the choice of the colorants because of printing system requirements such as good permanence or other factors.

In many cases, the color performance cannot be resolved by changing color maps of the inks because some of the primary colorants that are used for the inks are not true. Further, some inks may never be able to attain some desired secondary or tertiary colors. The problem may be made worse on some media types, such as photographic media.

The media can, in some instances, be changed to accommodate the ink in order to meet the color requirements, but this may result in detrimental changes to other aspects of performance. Thus, a need exists for ink-jet inks that have better color rendition.

In addition, a color ink set typically requires at least three to four different colorants, the fourth typically consisting of black. Some of these colorants may have suitable performance parameters, but an additional colorant with suitable color to match the preexisting colorants may not have as good a performance. In that situation, a different colorant with suitable performance but unsuitable color may have its color adjusted in order to optimize the color gamut of the ink set.

Additionally, some inks produce a desired color on certain media, but not on others. Consequently, a printing system must either employ different inks when printing on different media or achieve unsatisfactory color results on some media. The performance of such inks is referred to as “media dependent.” A color that is true, i.e., without a perceptible hue of a different color, is referred to as “neutral.”

The problems of media dependency may be particularly acute with the color black. Again, the ideal visual result with black colorant is referred to as “neutral” black, meaning that the resulting printing in the color black is without a residual hue such as green or blue.

### BRIEF DESCRIPTION OF THE DRAWINGS

The accompanying drawings illustrate embodiments of principles of the present invention and are a part of the specification. The illustrated embodiments are merely examples and do not limit the scope of the claims.

FIGS. 1 and 2 are graphs showing the color change of particular embodiments of ink compositions according to principles described herein.

### DETAILED DESCRIPTION

With the help of various exemplary embodiments, the present specification describes ink additives and methods for controlling the color of an ink composition on a print medium using the ink additive. Without being bound to any particular theory, it is understood that in at least one embodiment of an ink additive described herein, upon being printed on a print medium in an ink composition having a colorant, the ink additive changes how the colorant interacts with the print medium and, thus, changes the visible color of the colorant.

As used herein, “liquid vehicle” or “ink vehicle” will refer to the fluid in which colorants, latex particles, colloids, and/or other ink-jet ink constituents are dispersed to form inkjet inks. Suitable liquid vehicles and ink vehicle components include, but are not limited to, a variety of different agents, such as surfactants, co-solvents, buffers, biocides, sequestering agents, humectants, viscosity modifiers, water and any combination thereof. Other compounds that may serve as or be employed in the ink vehicle include, but are not limited to organic solvents, surface-active agents, metal chelators, and any combinations thereof. As will be apparent to one of skill in the art, the relative amounts of ink vehicle and the various constituents described herein may be varied to accommodate the specific pen architecture of the ink-jet printer.

As used herein and in the appended claims, the term “black colorant” will be understood to include any colorant that is intended to produce the color black, with or without full neutrality, when printed on a print medium. The term “black colorant” may include, but is not limited to, inks, dyes, toners, etc.

In one embodiment, water may make up a substantially large percentage of the overall ink vehicle or ink composition. For instance, the water may comprise purified or deionized water in an amount of from about 5 to about 95 percent by weight of the ink composition.

In another embodiment, a solvent or co-solvent may be included in the ink composition. Classes of co-solvents that may be used include aliphatic alcohols, aromatic alcohols, diols, glycol ethers, polyglycol ethers, formamides, acetamides, long chain alcohols and any combinations thereof. Examples of such solvents or co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs of polyethylene glycol alkyl ethers, both substituted and unsubstituted formamides, both substituted and unsubstituted acetamides, trimethylolpropane, 2-pyrrolidinone, 1,5-pentanediol, and any combination thereof.

In a further embodiment, an effective amount of a surfactant component of the ink composition may be achieved using a single surfactant ingredient or a mixture of surfactants. Generally, the surfactants may be used to increase the dispersion stability of the colorants and/or the latex particle, and to increase the penetration of the ink composition into the print medium. A wide array of surfactant classes may be used, including, but not limited to, cationic, anionic, zwitterionic or non-ionic surfactants. Non-limiting examples of surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, Rhodafac, sodium dodecylsulfate, Triton N and X-series, and any combinations thereof.

In another embodiment, the ink composition may include a biocide, fungicide or other antimicrobial agent capable of inhibiting the growth of microorganisms. Non-limiting examples of biocides that may be used include without limitation: NUOSEPT 95, available from Hals America (Piscataway, N.J.); PROXEL GXL, available from Arch Chemicals (Wilmington, Del.), glutaraldehyde, available from Union Carbide Company (Bound Brook, N.J.) under the trade designation UCARCIDE 250, and Vancide, available from R.T. Vanderbilt Co. and any combinations thereof.

In yet another embodiment, the ink composition may include a buffer agent. The buffer agents in the ink composition may be used to modulate pH. The buffer agent may be an organic-based biological buffer or an inorganic buffer. Non-limiting examples of buffers that may be used include Trizma base, available from Aldrich Chemical (Milwaukee, Wis.), 4-morpholineethanesulfonic acid (MES), 4-morpholinepropane sulfonic acid (MOPS), and any combinations thereof.

In another embodiment, the ink composition may include sequestering agents. One example of a sequestering agent is a metal chelating agent present in the ink composition. Metal chelating agents may be used to bind transition metal cations that may be present in the ink composition. Non-limiting examples of metal-chelating agents include ethylenediaminetetraacetic acid (EDTA), diethylenetriaminepentaacetic acid (DTPA), trans-1,2-diaminocyclohexanetetraacetic acid (CDTA), (ethylenedioxy) diethylenedinitrilotetraacetic acid (EGTA), other chelators that bind transition metal cations, and any combinations thereof.

As used herein, “effective amount” refers to the minimal amount of or concentration of a substance or agent, which is sufficient to achieve a desired effect. Amounts, concentrations, and other numerical data may be expressed or presented herein in a range format. It is to be understood that such a range format is used for convenience and, thus, should be interpreted in a flexible manner to include not only numerical values associated with the limits of the range, but also to include all the individual numerical values or sub-ranges encompassed within that range as if each numerical value and sub-range is explicitly stated.

As known by those of ordinary skill in the art, the CIE L*a*b* system is used to measure or specify the chromaticity (c*, square root of the sum of a*2 and b*2) or the properties of hue [arctan (b*/a*)] and saturation (c*/L*) on a two-dimensional chromaticity diagram. The a* measures redness-greenness on the x-axis, or the horizontal axis, and b* measures yellowness-blueness on the y-axis, or the vertical axis. The L* measures lightness-darkness on the z-axis. To assess the chromaticity of the ink compositions and the ability of the ink additives of the present invention to control the color of the colorant, the ink compositions were printed on media and the chromaticity was assessed using the CIE L*a*b* system. Thus the measurement of hue and chroma is a well-known measurement of color quality in printing.

Neutrality is the usual measure of the extent of undertone occurring in black and gray inks. It is not used to describe inks other than black or gray, i.e., colored inks. It is also often indicated in terms of hue and chroma. Such undertone lack has traditionally been used for black and gray inks. One fundamental limitation with the use of carbon black as the primary pigment in black and gray inks is the brownish or reddish undertone when it is used at low concentration as in gray ink. This is especially true with the photo grade carbon black.

The present invention relates to compositions and methods for printing black and colored inks consistently on various kinds of media, i.e. swellable, porous and plain paper, incurring very little difference in chroma and hue between the various media for a given ink,

In one embodiment, an ink composition comprises effective amounts of an ink vehicle, a colorant admixed in the ink vehicle, and an ink additive for controlling the color produced by the colorant. The color of the colorant may be controlled in various ways. For example, the neutrality of the colorant may be controlled and the media independence of the colorant may be controlled. In various embodiments, the ink additives may be present in the ink composition in a range of from about 0.1% to about 10% by weight of the ink composition.

An example of an ink additive used for controlling the color produced by the colorant of the ink composition includes, but is not limited to: amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-l-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

Other ink additives that may be used include compounds that can form salts and/or amines in the ink composition, such as, for example, caprolactam (i.e., by ring opening), urea and its derivatives (i.e., by decomposition) and any combination thereof.

It will be apparent to those of ordinary skill in the art that the type and amount of ink additive used for controlling the color of the ink composition may be varied and determined using routine experimentation in order to achieve or control a desired color. For instance, different ink additives may be selected for different colorants. Further, simple experimentation with a given colorant, ink additive and print medium may be used to determine the appropriate ink additive and concentration of the ink additive to be placed in the ink composition. In one embodiment, the ink additive is selected by placing a first ink composition without the ink additive on the print medium, placing a second ink composition with the ink additive on the print medium, and comparing a color of the first ink composition to a color of the second ink composition.

In another embodiment, the ink composition including the ink vehicle, the colorant, and the ink additive for controlling the color produced by the colorant is applied to or printed on a print medium using an ink-jet printer. The print media may include, without limitation, HP Premium Glossy Photo Paper (HPPGPP), Hewlett Packard Plain Paper (HPPP), and porous media such as Epson Premium Glossy Photo Paper (EPGPP), Other plain paper used in this application are HP Bright White (HPBW) and HP All In One (HPAIO).

In another embodiment, the colorant of the ink composition is dye-based. Non-limiting examples of colorants that may be used include Fast Black 2, DB199Na, Projet cyan 485, a mixture of RR23 and AR52, Y104, M700, Projet K820, Projet K287, DJR814, K-1334, and any combination thereof. Other dyes that may be used as the colorant include without limitation water-soluble dyes such as sulfonate and carboxylate dyes. Non-limiting examples include Sulforhodamine B, Acid Blue 113, Acid Blue 29, Acid Red 4, Rose Bengal, Acid Yellow 17, Acid Yellow 29, Acid Yellow 42, Acridine Yellow G, Nitro Blue Tetrazolium Chloride Monohydrate or Nitro BT, Rhodamine 6G, Rhodamine 123, Rhodamine B, Rhodamine B Isocyanate, Safranine O, Azure B, Azure B Eosinate, Basic Blue 47, Basic Blue 66, Thioflacin T, Auramine O, Direct Yellow 132, Direct Blue 199, Magenta 377, Acid Red 52 (AR52), and any combination thereof. Additional dyes that may be used include water-insoluble dyes, such as azo, xanthene, methane, polymethine, and anthroquinone dyes.

Different print media can include at least two different plain papers, a plain paper and a swellable medium, a plain paper and a porous medium, or a swellable and a porous medium, or any other combinations of media.

When referring to the ink-receiving layer of a print medium, this can include any coating that is used to accept an ink-jet ink to produce an image. There are at least two types of ink-receiving layers that can be used, including metal oxide or semi-metal oxide particulate-based ink-receiving layers, e.g., alumina- or silica-based, and polymeric swellable ink-receiving layers, e.g., gelatin or polyvinyl alcohol. The media substrate, for example, can be paper, plastic, coated paper, fabric, art paper, or other known substrate used in the ink-jet printing arts. In one embodiment, photobase can be used as the substrate. Photobase is typically a three-layered system comprising a single layer of paper sandwiched by two polymeric layers, such as polyethylene layers.

With respect to the ink-receiving layer, if a semi-metal oxide or metal oxide particulate-based ink-receiving layer is used; inorganic semi-metal or metal oxide particulates, a polymeric binder, and optionally, mordants and/or other porous coating composition agents can be present. In one embodiment, the inorganic semi-metal or metal oxide particulates can be silica, alumina, boehmite, silicates (such as aluminum silicate, magnesium silicate, and the like), titania, zirconia, calcium carbonate, clays, and combinations thereof. In a more detailed aspect, the particulates can be alumina, silica, or aluminosilicate. Each of these inorganic particulates can be dispersed throughout a porous coating composition, which can be applied to a media substrate to form the porous ink-receiving layer

Turning to the organic swellable ink-receiving layer that can be coated on the media substrate, hydrophilic compositions such as gelatin, polyvinyl alcohol, methyl cellulose, or the like can be applied. These compositions are polymeric in nature, and when an ink-jet ink is printed thereon, the polymeric coating that makes up the ink-receiving layer absorbs and traps the ink. These hydrophilic polymeric materials can be coated on a single side of a media substrate, or can be coated on both sides of a media substrate to provide a good printing surface for ink-jet ink applications, as well as to provide balance to the back of the substrate, preventing substrate curl that may occur with a paper substrate. Backcoats can also be applied to the media to prevent ink-transfer when stacking media after printing. An example of such media is described in U.S. Pat. No. 6,638,585, which is incorporated herein by reference.

The ink-receiving layer, whether primarily inorganic porous or organic swellable, can be a single layer or a multilayer coating designed to adsorb or absorb sufficient quantities of ink to produce high quality printed images. The coating composition may be applied to the media substrate to form the ink-receiving layer by any means known to one skilled in the art, including blade coating, air knife coating, rod coating, wire rod coating, roll coating, slot coating, slide hopper coating, gravure, curtain, and cascade coating. The ink-receiving layer can be printed on one or both sides of the media substrate

### EXAMPLES

The following examples describe various embodiments of ink compositions and methods for printing the ink compositions on a medium with a pen of an ink jet printer in accordance with principles described herein. The examples are merely illustrative and are not meant to limit the scope of the claims in any way. The following examples, except where otherwise noted, use an ink vehicle including approximately 10% DEG, 1.5% Triton X-100, and 0.2% Trizma base. In the examples, the pH is between about 8 to about 8.5. The dyes used here in the inks of the present examples were from 0.5-6 wt % in the ink vehicle.

### Example I

Various ink additives for affecting chroma of a colorant were admixed with several different inks, each having a colorant in an ink vehicle. The colorants used in this example were black colorants such as K1334 and K820. The specific additive and colorant used for each ink were tabulated in Table 1. Each numbered ink was printed on a given print medium in both its additive-containing state and its control state. Chroma data for both the additive-containing ink and the control printed on the medium were determined and the difference for each ink was calculated at a given print fill density. The results for each numbered ink in terms of chroma difference and print density were compared with all the other inks tested below in Table 1.

TABLE 1
Chroma difference between additive-containing ink and control (no additive
ink) on a given medium such as porous (EPGPP), swellable (HPPGPP) and plain (HPPP).

| | | | | | | | Print |
|---|---|---|---|---|---|---|---|
| | | | | c* | | c* (Cont) − c* | Fill |
| Ink | Dye | Media | Additive | (Addit) | c* (Cont) | (Addit) | Density |
| 1 | K1334 | EPGPP | Glycine | 12.3 | 15.4 | 3.1 | 80 |
| 2 | K1334 | EPGPP | Urea | 15.3 | 15.4 | 0.1 | 80 |
| 3 | K1334 | EPGPP | KH₂PO₄ | 13.3 | 15.3 | 2 | 80 |
| 4 | K1334 | EPGPP | Na benzoate | 13 | 15.3 | 2.3 | 80 |
| 5 | K1334 | EPGPP | Succinic acid | 15.5 | 17.4 | 1.9 | 20 |
| 6 | K1334 | EPGPP | Butyric acid | 18.8 | 19.7 | 0.9 | 40 |
| 7 | K1334 | EPGPP | NaCl | 11.8 | 16.7 | 4.9 | 20 |
| 8 | K1334 | EPGPP | NaNO₃ | 13.7 | 16.7 | 3 | 20 |
| 9 | K820 | EPGPP | Na methane | 11.8 | 16.8 | 5 | 40 |
| | | | sulfonate | | | | |
| 10 | K820 | EPGPP | Na succinate | 15.2 | 20.2 | 5 | 60 |
| 11 | K820 | EPGPP | NaNO₃ | 10.3 | 16.8 | 6.5 | 40 |
| 12 | K820 | EPGPP | Na gluconate | 19.1 | 20.2 | 1.1 | 60 |
| | | | (20% 2- | | | | |
| | | | pyrrolidinone) | | | | |
| 13 | K820 | EPGPP | NaCl | 10.6 | 16.8 | 6.2 | 40 |
| 14 | K820 | EPGPP | Mucic acid | 13.5 | 20.8 | 7.3 | 40 |
| 15 | K820 | EPGPP | Gluconic acid | 18.9 | 20.8 | 1.9 | 40 |
| 16 | K820 | EPGPP | NaCl (0.19%) | 21 | 21.4 | 0.4 | 40 |
| 17 | K820 | EPGPP | NaCl (0.37%) | 18.9 | 21.4 | 2.5 | 40 |
| 18 | K820 | EPGPP | Na acetate | 12.1 | 17.6 | 5.5 | 20 |
| 19 | K820 | EPGPP | NaH₂PO₄ | 11.9 | 17.6 | 5.7 | 20 |
| 20 | K820 | EPGPP | 1,3-benzenedisulfonic | 12.1 | 18.4 | 6.3 | 20 |
| | | | acid | | | | |
| 21 | K820 | EPGPP | Anthraquinone- | 17.3 | 18.4 | 1.1 | 20 |
| | | | 2-sulfonic acid | | | | |
| 22 | K820 | EPGPP | Na benzoate | 12.9 | 17.5 | 4.6 | 20 |
| 23 | K820 | EPGPP | 1-hydroxy-2- | 13.8 | 17.5 | 3.7 | 20 |
| | | | naphthoic acid | | | | |
| 24 | K1334 | HPPGPP | KH₂PO₄ | 11.7 | 13.5 | 1.8 | 60 |
| 25 | K1334 | HPPGPP | Na benzoate | 12.2 | 13.5 | 1.3 | 60 |
| 26 | K1334 | HPPGPP | Succinic acid | 19.3 | 21.6 | 2.3 | 60 |
| 27 | K1334 | HPPGPP | Butyric acid | 13.1 | 17.4 | 4.3 | 20 |
| 28 | K1334 | HPPGPP | NaCl | 9.5 | 11.3 | 1.8 | 120 |
| 29 | K1334 | HPPGPP | NaNO₃ | 8.9 | 11.3 | 2.4 | 120 |
| 30 | K820 | HPPGPP | Na methane | 18.4 | 19.1 | 0.7 | 60 |
| | | | sulfonate | | | | |
| 31 | K820 | HPPGPP | Na succinate | 17.6 | 19.1 | 1.5 | 60 |
| 32 | K820 | HPPGPP | NaNO₃ | 17.6 | 19.1 | 1.5 | 60 |
| 33 | K820 | HPPGPP | Na gluconate | 18.5 | 19.1 | 0.6 | 60 |
| | | | (20% 2- | | | | |
| | | | pyrrolidinone) | | | | |
| 34 | K820 | HPPGPP | NaCl | 16.8 | 19.1 | 2.3 | 60 |
| 35 | K820 | HPPGPP | Butyric acid | 15.2 | 16.2 | 1 | 20 |
| 36 | K820 | HPPGPP | Succinic acid | 8.1 | 10.5 | 2.4 | 120 |
| 37 | K820 | HPPGPP | Mucic acid | 12.6 | 20.6 | 8 | 40 |
| 38 | K820 | HPPGPP | Gluconic acid | 19.8 | 20.6 | 0.8 | 40 |
| 39 | K820 | HPPGPP | Na acetate | 17 | 18 | 1 | 60 |
| 40 | K820 | HPPGPP | NaH₂PO₄ | 17.2 | 19.4 | 2.2 | 40 |
| 41 | K820 | HPPGPP | 1,3- | 19 | 20.1 | 1.1 | 40 |
| | | | benzenesulfonic | | | | |
| | | | acid | | | | |
| 42 | K820 | HPPGPP | Anthraquinone- | 18.7 | 20.1 | 1.4 | 40 |
| | | | 2-sulfonic acid | | | | |
| 43 | K820 | HPPGPP | Na benzoate | 8.5 | 10 | 1.5 | 100 |
| 44 | K820 | HPPGPP | 1-hydroxy-2- | 15.5 | 16.9 | 1.4 | 20 |
| | | | naphthoic acid | | | | |
| 45 | K1334 | HPPP | Succinic acid | 11.9 | 12.8 | 0.9 | 80 |
| 46 | K1334 | HPPP | Butyric acid | 12.3 | 12.8 | 0.5 | 80 |
| 47 | K1334 | HPPP | NaCl | 11.7 | 12.5 | 0.8 | 100 |
| 48 | K1334 | HPPP | NaNO₃ | 11.6 | 12.5 | 0.9 | 100 |
| 49 | K820 | HPPP | Na | 10.9 | 11.9 | 1 | 80 |
| | | | methanesulfonate | | | | |
| | | | (25.2) | | | | |
| 50 | K820 | HPPP | Na gluconate | 11.5 | 12.3 | 0.8 | 60 |
| | | | (11.11) | | | | |
| 51 | K820 | HPPP | Butyric acid | 10.8 | 11.9 | 1.1 | 80 |
| | | | (28.2) | | | | |
| 52 | K820 | HPPP | Succinic acid | 10.9 | 12.3 | 1.4 | 60 |
| | | | (28.7) | | | | |
| 53 | K820 | HPPP | NaNO₃ (40.8) | 10.2 | 11.5 | 1.3 | 120 |
| 54 | K820 | HPPP | NaCl (59.6) | 10.6 | 11.9 | 1.3 | 80 |
| 55 | K820 | HPPP | Mucic acid | 12.7 | 13.7 | 1 | 20 |
| 56 | K820 | HPPP | Gluconic acid | 13.2 | 13.8 | 0.6 | 40 |
| 57 | K820 | HPPP | Na acetate | 11.6 | 12.3 | 0.7 | 40 |
| 58 | K820 | HPPP | NaH₂PO₄ | 10.5 | 11.8 | 1.3 | 20 |
| 59 | K820 | HPPP | Na benzoate | 11.1 | 11.5 | 0.4 | 100 |

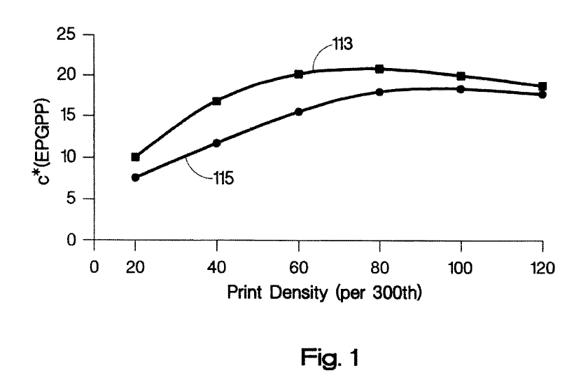

As illustrated in Table 1, as print fill density increased, the chroma increased less when ink additive was present than when it was not present.
In FIG. 1, a graph showing the chroma difference of ink 9 of Table 1is shown at increasing print fill densities. With the X axis measuring Print Fill Density (per 300^{th} ) and the Y axis measure c*, the plot of the increase in c* with the additive (115) is compared with the plot of increase in c* without the additive (control)(113). It can be seen from FIG. 1, that the additive-containing ink 9 consistently produces lower chroma than the ink 9 without additive over various print fill densities.

### Example II

Various ink additives affecting hue angle of a colorant were admixed with several difference inks, each having a colorant in an ink vehicle. The colorants used in this example were of various colors as well as black, such as AR52N and C485. The specific additive and colorant used for each ink were tabulated in Table 2. Each numbered ink was printed on a porous print medium (EPGPP) and a swellable print medium (HPPGPP) in both its additive-containing state and its control state. The hue angle difference (h*) between the porous and swellable print media for both the additive-containing ink and the control ink printed on both media are determined for a give ink and at a given print fill density. Furthermore, the absolute value difference between the two h* differences, additive-containing and control, for each ink was calculated, again at a given print fill density. The result for each numbered ink in terms of absolute value of hue angle difference and print fill density were compared with all the other inks tested below in Table 2.

TABLE 2
Absolute value of hue angle difference between porous (EPGPP)
and swellable (HPPGPP) media

| | | | | | | h* | |
|---|---|---|---|---|---|---|---|
| | | | | | | difference | |
| | | | | h* | h* | (Cont) − h* | |
| | | | | difference | difference | difference | Print |
| Ink | Dye | Media | Additive | (Addit) | (Cont) | (Addit) | Density |
| 60 | AR52Na | EPGPP- | Triethanolamine | 0 | 0.7 | 0.7 | 40 |
| | | HPPGPP | 5% | | | | |
| 61 | AR52Na | EPGPP- | Triethanolamine | 0 | 0.8 | 0.8 | 120 |
| | | HPPGPP | 2.5% | | | | |
| 62 | AR52Na | EPGPP- | NaCl | 0.3 | 1.6 | 1.3 | 80 |
| | | HPPGPP | | | | | |
| 63 | AR52Na | EPGPP- | NaNO₃ | 2.4 | 3.2 | 0.8 | 20 |
| | | HPPGPP | | | | | |
| 64 | C485 | EPGPP- | Na acetate | 9.9 | 17.1 | 7.2 | 80 |
| | | HPPGPP | | | | | |
| 65 | C485 | EPGPP- | NaH₂PO₄ | 13.2 | 23.2 | 10 | 120 |
| | | HPPGPP | | | | | |
| 66 | C485 | HPPGPP- | 3PC | 0.3 | 1.9 | 1.6 | 60 |
| | | EPGPP | | | | | |
| 67 | C485 | HPPGPP- | Caprolactam | 1.1 | 5.7 | 4.6 | 120 |
| | | EPGPP | | | | | |
| 68 | C485 | HPPGPP- | 2-hydroxyethyl | 0 | 0.8 | 0.8 | 80 |
| | | EPGPP | Piperidine | | | | |
| 69 | C485 | HPPGPP- | 1,3- | 2.3 | 5.7 | 3.4 | 120 |
| | | EPGPP | benzenedisulfonic | | | | |
| | | | acid | | | | |
| 70 | C485 | HPPGPP- | Homopiperazine | 1 | 4.4 | 3.4 | 40 |
| | | EPGPP | | | | | |
| 71 | C485 | HPPGPP- | 1-hydroxy-2- | 2.7 | 5.7 | 3 | 120 |
| | | EPGPP | naphthoic acid | | | | |
| 72 | C485 | HPPGPP- | DL-threonine | 2.9 | 5.7 | 2.8 | 120 |
| | | EPGPP | | | | | |
| 73 | C485 | HPPGPP- | Urea | 0.8 | 1.9 | 1.1 | 60 |
| | | EPGPP | | | | | |
| 74 | C485 | HPPGPP- | MOPS buffer | 1.2 | 4.4 | 3.2 | 40 |
| | | EPGPP | | | | | |
| 75 | C485 | HPPGPP- | Hexanoic acid | 2.1 | 4.4 | 2.3 | 40 |
| | | EPGPP | | | | | |
| 76 | DB199Na | EPGPP- | NaCl (38.7) | 1.2 | 2.2 | 1 | 40 |
| | | HPPGPP | | | | | |
| 77 | DB199Na | EPGPP- | Triethanolamine | 1.9 | 4.8 | 2.9 | 100 |
| | | HPPGPP | (6.34) | | | | |
| 78 | DB199Na | EPGPP- | Na benzoate | 0.8 | 3.7 | 2.9 | 100 |
| | | HPPGPP | (11.01) | | | | |
| 79 | DB199Na | EPGPP- | 1-hydroxy-2- | 1 | 2.4 | 1.4 | 60 |
| | | HPPGPP | naphthoic acid | | | | |
| | | | (10.12) | | | | |
| 80 | K1334 | EPGPP- | 3-pyridyl carbinol | 8.4 | 10.7 | 2.3 | 60 |
| | | HPPGPP | (3PC) | | | | |
| 81 | K1334 | EPGPP- | Glycine | 7 | 1.7 | 4.7 | 100 |
| | | HPPGPP | | | | | |
| 82 | K1334 | EPGPP- | Imidazole | 9.9 | 16.1 | 6.2 | 40 |
| | | HPPGPP | | | | | |
| 83 | K1334 | EPGPP- | Urea | 14.5 | 16.1 | 1.6 | 40 |
| | | HPPGPP | | | | | |
| 84 | K820 | EPGPP- | Anthraquinone-2- | 1.7 | 2.5 | 0.8 | 40 |
| | | HPPGPP | sulfonic acid | | | | |
| 85 | M377 | EPGPP- | 1,3- | 0.9 | 2.2 | 1.3 | 20 |
| | | HPPGPP | benzenedisulfonic | | | | |
| | | | acid | | | | |
| 86 | M377 | EPGPP- | Anthraquinone-2- | 4.3 | 5 | 0.7 | 100 |
| | | HPPGPP | sulfonic acid | | | | |
| 87 | Y104 | EPGPP- | Anthraquinone-2- | 2.85 | 2.86 | 0.01 | 80 |
| | | HPPGPP | sulfonic acid | | | | |

As illustrated in Table 2, the hue angle difference between an additive-containing ink printed on porous media and the same ink printed on swellable media is usually substantially less than the control ink hue angle difference.

### Example III

Various ink additives affecting hue angle of a colorant were admixed with several different inks, each having a colorant in an ink vehicle. The colorants used in this example were of various colors as well as black, such as AR52Na and C485. The specific additive and colorant used for each ink were tabulated in Table 3. Each numbered ink is printed on a porous print medium (EPGPP) and a plain print medium (HPPP, unless otherwise noted) in both its additive-containing state and its control state. The hue angle difference (h*) between the porous and plain paper print media for both the additive-containing ink and the control ink printed on both media were determined for a given ink and at a give print fill density. Furthermore, the absolute value difference between the two h* difference, additive-containing and control, for each ink was calculated, again at a given print fill density. The result for each numbered ink in terms of absolute value of hue angle difference and print fill density were compared with all the other inks tested below in Table 3.

TABLE 3
Absolute value of hue angle difference between porous media (EPGPP)
and plain paper (HPPP) (unless otherwise noted)

| | | | | | | h* | |
|---|---|---|---|---|---|---|---|
| | | | | | | difference | |
| | | | | h* | h* | (Cont) − h* | |
| | | | | difference | difference | difference | Print |
| Ink | Dye | Media | Additive | (Addit) | (Cont) | (Addit) | Density |
| 88 | AR52Na | h*—h* | Ca gluconate | 7.2 | 10.5 | 3.3 | 60 |
| | | (HPPP) | | | | | |
| 89 | AR52Na | h*—h* | KH2PO4 | 9.7 | 10.3 | 0.6 | 40 |
| | | (HPPP) | | | | | |
| 90 | AR52Na | h*—h* | Imidazole | 7.2 | 10.3 | 3.1 | 40 |
| | | (HPPP) | | | | | |
| 91 | AR52Na | h*—h* | Urea | 9 | 9.5 | 0.5 | 100 |
| | | (HPPP) | | | | | |
| 92 | AR52Na | h*—h* | Triethanolamine | 10.1 | 10.5 | 0.4 | 60 |
| | | (HPPP) | | | | | |
| 93 | AR52Na | h*—h* | Homopiperazine | 6.2 | 10.3 | 4.1 | 40 |
| | | (HPPP) | | | | | |
| 94 | AR52Na | h*—h* | MES buffer | 10 | 10.5 | 0.5 | 60 |
| | | (HPPP) | | | | | |
| 95 | AR52Na | h*—h* | Na salicylate | 8.7 | 10.5 | 1.8 | 80 |
| | | (HPPP) | | | | | |
| 96 | AR52Na | h*—h* | NaCl | 8.1 | 10.5 | 2.4 | 60 |
| | | (HPPP) | | | | | |
| 97 | AR52Na | h*—h* | LiNO3 | 8 | 9.5 | 1.5 | 100 |
| | | (HPPP) | | | | | |
| 98 | AR52Na | h*—h* | Na | 4 | 5.3 | 1.3 | 20 |
| | | (HPPP) | methanesulfonate | | | | |
| 99 | AR52Na | h*—h* | NaCl | 4.6 | 5.3 | 0.7 | 40 |
| | | (HPPP) | | | | | |
| 100 | AR52Na | h*—h* | NaNO3 | 4.3 | 5.3 | 1 | 40 |
| | | (HPPP) | | | | | |
| 101 | C485 | h*—h* | Na acetate | 0.5 | 25 | 24.5 | 100 |
| | | (HPPP) | | | | | |
| 102 | C485 | h*—h* | NaH2PO4 | 13.4 | 24.9 | 11.5 | 80 |
| | | (HPPP) | | | | | |
| 103 | C485 | h*—h* | Na acetate | 1.6 | 27.1 | 25.5 | 100 |
| | | (GPMS) | | | | | |
| 104 | C485 | h*—h* | NaH2PO4 | 10.4 | 27.1 | 16.7 | 100 |
| | | (GPMS) | | | | | |
| 105 | C485 | h*—h* | 3PC | 11.3 | 15.8 | 4.5 | 60 |
| | | (HPAIO) | | | | | |
| 106 | C485 | h*—h* | Caprolactam | 18.4 | 21.5 | 3.1 | 20 |
| | | (HPAIO) | | | | | |
| 107 | C485 | h*—h* | 2-hydroxyethyl | 7.2 | 12.5 | 5.3 | 120 |
| | | (HPAIO) | piperidine | | | | |
| 108 | C485 | h*—h* | Urea | 11 | 13.1 | 2.1 | 100 |
| | | (HPAIO) | | | | | |
| 109 | C485 | h*—h* | 1,3-benzenedisulfonic | 18.8 | 21.5 | 2.7 | 20 |
| | | (HPAIO) | acid | | | | |
| 110 | C485 | h*—h* | Homopiperazine | 5.1 | 14.1 | 9 | 80 |
| | | (HPAIO) | | | | | |
| 111 | C485 | h*—h* | 1-hydroxy-2- | 9.2 | 14.1 | 4.9 | 80 |
| | | (HPAIO) | naphthoic acid | | | | |
| 112 | C485 | h*—h* | DL-threonine | 15.9 | 18.1 | 2.2 | 40 |
| | | (HPAIO) | | | | | |
| 113 | C485 | h*—h* | MOPS buffer | 4.3 | 12.5 | 8.2 | 120 |
| | | (HPAIO) | | | | | |
| 114 | C485 | h*—h* | Hexanoic acid | 6.1 | 12.5 | 6.4 | 120 |
| | | (HPAIO) | | | | | |
| 115 | C485 | h*—h* | Na acetate | 10.1 | 31 | 20.9 | 80 |
| | | (HPBW) | | | | | |
| 116 | C485 | h*—h* | NaH2PO4 | 18 | 31 | 13 | 80 |
| | | (HPBW) | | | | | |
| 117 | DB199Na | h*—h* | Triethanolamine | 2.7 | 13.9 | 11.2 | 80 |
| | | (HPPP) | (6.34) | | | | |
| 118 | DB199Na | h*—h* | Na benzoate | 0.3 | 12.2 | 11.9 | 100 |
| | | (HPPP) | | | | | |
| 119 | DB199Na | h*—h* | 1-hydroxy-2- | 8.3 | 14.4 | 6.1 | 80 |
| | | (HPPP) | naphthoic acid | | | | |
| 120 | K1334 | h*—h* | 3-pyridylcarbinol | 0.2 | 5.5 | 5.3 | 120 |
| | | (HPPP) | | | | | |
| 121 | K1334 | h*—h* | Triethanolamine | 1.8 | 4.5 | 2.7 | 60 |
| | | (HPPP) | | | | | |
| 122 | K1334 | h*—h* | Glycine | 1.3 | 6 | 4.7 | 60 |
| | | (HPPP) | | | | | |
| 123 | K1334 | h*—h* | Tris | 0 | 2.5 | 2.5 | 80 |
| | | (HPPP) | | | | | |
| 124 | K1334 | h*—h* | Imidazole | 1 | 3.5 | 2.5 | 120 |
| | | (HPPP) | | | | | |
| 125 | K1334 | h*—h* | KH2PO4 | 0.9 | 5.9 | 5 | 60 |
| | | (HPPP) | | | | | |
| 126 | K1334 | h*—h* | Na benzoate | 0.1 | 5.9 | 5.8 | 60 |
| | | (HPPP) | | | | | |
| 127 | K1334 | h*—h* | Succinic acid | 21.6 | 27.8 | 6.2 | 100 |
| | | (HPPP) | | | | | |
| 128 | K1334 | h*—h* | Butyric acid | 5.5 | 12.6 | 7.1 | 20 |
| | | (HPPP) | | | | | |
| 129 | K1334 | h*—h* | NaCl | 1 | 12.2 | 11.2 | 20 |
| | | (HPPP) | | | | | |
| 130 | K1334 | h*—h* | NaNO3 | 3.7 | 12.2 | 8.5 | 20 |
| | | (HPPP) | | | | | |
| 131 | K820 | h*—h* | Na | 8.4 | 18.5 | 10.1 | 20 |
| | | (HPPP) | methanesulfonate | | | | |
| 132 | K820 | h*—h* | Na succinate | 9.8 | 18.5 | 8.7 | 40 |
| | | (HPPP) | | | | | |
| 133 | K820 | h*—h* | NaNO3 | 1 | 18.5 | 17.5 | 40 |
| | | (HPPP) | | | | | |
| 134 | K820 | h*—h* | Na gluconate | 12.1 | 18.5 | 6.4 | 40 |
| | | (HPPP) | | | | | |
| 135 | K820 | h*—h* | NaCl | 3.3 | 18.5 | 15.2 | 40 |
| | | (HPPP) | | | | | |
| 136 | K820 | h*—h* | Glucoheptonic acid | 0.1 | 1.5 | 1.4 | 80 |
| | | (HPPP) | | | | | |
| 137 | K820 | h*—h* | Lactobionic acid | 13.6 | 14.9 | 1.3 | 20 |
| | | (HPPP) | | | | | |
| 138 | K820 | h*—h* | Mucic acid (0.5%) | 4.8 | 10.5 | 5.7 | 40 |
| | | (HPPP) | | | | | |
| 139 | K820 | h*—h* | Mucic acid (1%) | 6.5 | 10.5 | 4 | 40 |
| | | (HPPP) | | | | | |
| 140 | K820 | h*—h* | 1,3-benzenedisulfonic | 25 | 28 | 3 | 120 |
| | | (HPPP) | acid | | | | |
| 141 | K820 | h*—h* | Anthraquinone-2- | 20 | 21 | 1 | 60 |
| | | (HPPP) | sulfonic acid | | | | |
| 142 | M377 | h*—h* | NaH2PO4 | 11.1 | 12.4 | 1.3 | 120 |
| | | (HPPP) | | | | | |
| 143 | M377 | h*—h* | 1,3-benzenedisulfonic | 0.9 | 2.2 | 1.3 | 20 |
| | | (HPPP) | acid | | | | |
| 144 | M377 | h*—h* | Anthraquinone-2- | 1.6 | 2.2 | 0.6 | 20 |
| | | (HPPP) | sulfonic acid | | | | |
| 145 | Y104 | h*—h* | Anthraquinone-2- | 1.3 | 1.6 | 0.3 | 120 |
| | | (HPPP) | sulfonic acid | | | | |

As illustrated in Table 2, the hue angle difference between an additive-containing ink printed on porous media and the same ink printed on plain paper media is usually substantially less than the control ink hue angle difference.

### Example IV

Various ink additives affecting hue angle of a colorant were admixed with several different inks, each having a colorant in an ink vehicle. The colorants used in this example were of various colors as well as black, such as AR52Na and C485. The specific additive and colorant used for each ink were tabulated in Table 4. Each numbered ink was printed on a swellable print medium (HPPGPP) and a plain print medium (HPPP, unless otherwise noted) in both its additive-containing state and its control state. The hue angle difference (h*) between the swellable and plain paper print media for both the additive-containing ink and the control ink printed on both media were determined for a given ink and at a given print fill density. Furthermore, the absolute value difference between the two h* differences, additive-containing and control, for each ink was calculated, again at a given print fill density. The result for each numbered ink in terms of absolute value of hue angle difference and print fill density were compared with all the other inks tested below in Table 4.

TABLE 4
Absolute value of hue angle difference between swellable media (HPPGPP)
and plain paper (HPPP, unless otherwise noted).

| | | | | | | h* | |
|---|---|---|---|---|---|---|---|
| | | | | | | difference | |
| | | | | h* | h* | (Cont) − h* | |
| | | | | difference | difference | difference | Print |
| Ink | Dye | Media | Additive | (Addit) | (Cont) | (Addit) | Density |
| 146 | AR52Na | h*—h* | Na gluconate | 9.4 | 9.5 | 0.1 | 100 |
| | | (HPPP) | | | | | |
| 147 | AR52Na | h*—h* | Ca gluconate | 8.9 | 11.2 | 2.3 | 80 |
| | | (HPPP) | | | | | |
| 148 | AR52Na | h*—h* | Urea | 10.5 | 11.2 | 0.7 | 80 |
| | | (HPPP) | | | | | |
| 149 | AR52Na | h*—h* | Homopiperazine | 8.8 | 11.2 | 2.4 | 80 |
| | | (HPPP) | | | | | |
| 150 | AR52Na | h*—h* | Na salicylate | 9.3 | 13.4 | 4.1 | 40 |
| | | (HPPP) | | | | | |
| 151 | AR52Na | h*—h* | LiNO3 | 12 | 12.3 | 0.3 | 60 |
| | | (HPPP) | | | | | |
| 152 | AR52Na | h*—h* | Na | 4.5 | 5.6 | 1.1 | 20 |
| | | (HPPP) | methanesulfonate | | | | |
| 153 | AR52Na | h*—h* | Na gluconate | 5.1 | 5.6 | 0.5 | 20 |
| | | (HPPP) | | | | | |
| 154 | AR52Na | h*—h* | NaNO3 | 6.5 | 8.4 | 1.9 | 20 |
| | | (HPPP) | | | | | |
| 155 | C485 | h*—h* | Triethanolamine | 3 | 12.2 | 9.2 | 60 |
| | | (HPPP) | 5% | | | | |
| 156 | C485 | h*—h* | Triethanolamine | 4.4 | 12.2 | 7.8 | 60 |
| | | (HPPP) | 2.5% | | | | |
| 157 | C485 | h*—h* | Triethanolamine | 4.2 | 14.1 | 9.9 | 80 |
| | | (HPBW) | 5% | | | | |
| 158 | C485 | h*—h* | Triethanolamine | 5.7 | 14.1 | 8.4 | 80 |
| | | (HPBW) | 2.5% | | | | |
| 159 | C485 | h*—h* | Na acetate | 0.2 | 10.2 | 10 | 60 |
| | | (HPPP) | | | | | |
| 160 | C485 | h*—h* | NaH2PO4 | 2.7 | 10.2 | 7.5 | 60 |
| | | (HPPP) | | | | | |
| 161 | C485 | h*—h* | 3-pyridylcarbinol | 12.9 | 16.4 | 3.5 | 100 |
| | | (HPAIO) | | | | | |
| 162 | C485 | h*—h* | Caprolactam | 6 | 17 | 11 | 20 |
| | | (HPAIO) | | | | | |
| 163 | C485 | h*—h* | KCl | 8.9 | 16.4 | 7.5 | 100 |
| | | (HPAIO) | | | | | |
| 164 | C485 | h*—h* | 2-hydroxy | 10.5 | 14.9 | 4.4 | 80 |
| | | (HPAIO) | ethylpiperidine | | | | |
| 165 | C485 | h*—h* | 1,3-benzenedisulfonic | 12.9 | 18.2 | 5.3 | 120 |
| | | (HPAIO) | acid | | | | |
| 166 | C485 | h*—h* | Homopiperazine | 4.4 | 14.9 | 10.9 | 80 |
| | | (HPAIO) | | | | | |
| 167 | C485 | h*—h* | 1-hydroxy-2- | 9.3 | 14.9 | 5.6 | 80 |
| | | (HPAIO) | naphthoic acid | | | | |
| 168 | C485 | h*—h* | DL-threonine | 10 | 14.9 | 4.9 | 80 |
| | | (HPAIO) | | | | | |
| 169 | C485 | h*—h* | Urea | 15.1 | 16.4 | 1.3 | 100 |
| | | (HPAIO) | | | | | |
| 170 | C485 | h*—h* | MOPS buffer | 10.2 | 14.9 | 4.7 | 100 |
| | | (HPAIO) | | | | | |
| 171 | C485 | h*—h* | Hexanoic acid | 0.9 | 18.2 | 17.3 | 120 |
| | | (HPAIO) | | | | | |
| 172 | C485 | h*—h* | Triethanolamine | 0.4 | 10.9 | 10.5 | 80 |
| | | (HPBW) | 5% | | | | |
| 173 | C485 | h*—h* | Triethanolamine | 1.8 | 10.9 | 9.1 | 80 |
| | | (HPBW) | 2.5% | | | | |
| 174 | C485 | h*—h* | Na acetate | 0.2 | 13.9 | 13.7 | 80 |
| | | (HPBW) | | | | | |
| 175 | C485 | h*—h* | NaH2PO4 | 2.1 | 13.9 | 11.8 | 80 |
| | | (HPBW) | | | | | |
| 176 | C485 | h*—h* | Na acetate | 1.6 | 11.7 | 10.1 | 60 |
| | | (GPMS) | | | | | |
| 177 | C485 | h*—h* | NaH2PO4 | 1.2 | 9.5 | 8.3 | 80 |
| | | (GPMS) | | | | | |
| 178 | DB199Na | h*—h* | 4,5-dihydroxy-1,3- | 2 | 9.3 | 7.3 | 80 |
| | | (HPPP) | benzenedisulfonic | | | | |
| | | | acid | | | | |
| 179 | DB199Na | h*—h* | NaCl | 12.2 | 18.2 | 6 | 80 |
| | | (HPPP) | | | | | |
| 180 | DB199Na | h*—h* | Triethanolamine | 0.3 | 18.2 | 17.9 | 80 |
| | | (HPPP) | | | | | |
| 181 | DB199Na | h*—h* | Na benzoate | 0.5 | 15.9 | 15.4 | 100 |
| | | (HPPP) | | | | | |
| 182 | DB199Na | h*—h* | 1-hydroxy-2- | 5.7 | 13.2 | 7.5 | 120 |
| | | (HPPP) | naphthoic acid | | | | |
| 183 | K1334 | h*—h* | Triethanolamine; | 26.9 | 23 | −3.9 | 20 |
| | | (HPPP) | | | | | |
| 184 | K1334 | h*—h* | Glycine | 3.3 | 13.7 | 10.4 | 80 |
| | | (HPPP) | | | | | |
| 185 | K1334 | h*—h* | Tris | 4.1 | 6.7 | 2.6 | 120 |
| | | (HPPP) | | | | | |
| 186 | K1334 | h*—h* | Urea | 22.5 | 23.9 | 1.4 | 40 |
| | | (HPPP) | | | | | |
| 187 | K1334 | h*—h* | Na benzoate | 22.6 | 23.9 | 1.3 | 20 |
| | | (HPPP) | | | | | |
| 188 | K1334 | h*—h* | Succinic acid | 13.9 | 20.7 | 6.8 | 80 |
| | | (HPPP) | | | | | |
| 189 | K1334 | h*—h* | Butyric acid | 14.5 | 20.7 | 6.2 | 80 |
| | | (HPPP) | | | | | |
| 190 | K1334 | h*—h* | NaCl | 14.2 | 5.9 | 1.7 | 40 |
| | | (HPPP) | | | | | |
| 191 | K1334 | h*—h* | NaNO3 | 4.1 | 5.9 | 1.8 | 40 |
| | | (HPPP) | | | | | |
| 192 | K820 | h*—h* | Na | 1.9 | 4.1 | 2.2 | 100 |
| | | (HPPP) | methanesulfonate | | | | |
| 193 | K820 | h*—h* | Na succinate | 1.6 | 4.1 | 2.5 | 100 |
| | | (HPPP) | | | | | |
| 194 | K820 | h*—h* | NaNO3 | 1.1 | 4.9 | 3.8 | 80 |
| | | (HPPP) | | | | | |
| 195 | K820 | h*—h* | Na gluconate (20% | 4.1 | 4.1 | 0 | 100 |
| | | (HPPP) | 2-pyrrolidinone) | | | | |
| 196 | K820 | h*—h* | NaCl | 26.9 | 29.3 | 2.4 | 20 |
| | | (HPPP) | | | | | |
| 197 | K820 | h*—h* | Glucoheptonic acid | 4.5 | 8.1 | 3.6 | 40 |
| | | (HPPP) | | | | | |
| 198 | K820 | h*—h* | Lactobionic acid | 5.4 | 8.1 | 2.7 | 40 |
| | | (HPPP) | | | | | |
| 199 | K820 | h*—h* | Mucic acid (0.5%) | 1.2 | 5.3 | 4.1 | 40 |
| | | (HPPP) | | | | | |
| 200 | K820 | h*—h* | Mucic acid (1%) | 4.3 | 10.1 | 5.8 | 20 |
| | | (HPPP) | | | | | |
| 201 | K820 | h*—h* | Na acetate | 8.3 | 11.4 | 3.1 | 60 |
| | | (HPPP) | | | | | |
| 202 | K820 | h*—h* | NaH2PO4 | 1.6 | 11.4 | 9.8 | 60 |
| | | (HPPP) | | | | | |
| 203 | K820 | h*—h* | 1,3-benzenedisulfonic | 11.8 | 16.5 | 4.7 | 60 |
| | | (HPPP) | acid | | | | |
| 204 | M377 | h*—h* | Anthraquinone-2- | 15 | 16.5 | 1.5 | 60 |
| | | (HPPP) | sulfonic acid | | | | |
| 205 | M377 | h*—h* | NaH2PO4 | 0.6 | 1.5 | 0.9 | 40 |
| | | (HPPP) | | | | | |
| 206 | M377 | h*—h* | Na acetate | 0.8 | 1.5 | 0.7 | 40 |
| | | (HPPP) | | | | | |
| 207 | M377 | h*—h* | 1,3- | 3.1 | 4.6 | 1.5 | 20 |
| | | (HPPP) | benzenedisulfonic | | | | |
| | | | acid | | | | |
| 208 | M377 | h*—h* | Anthraquinone-2- | 2.6 | 3.8 | 1.2 | 60 |
| | | (HPPP) | sulfonic acid | | | | |
| 209 | Y104 | h*—h* | 1,3- | 1.7 | 2.1 | 0.4 | 60 |
| | | (HPPP) | benzenedisulfonic | | | | |
| | | | acid | | | | |
| 210 | Y104 | h*—h* | Na Acetate | 0.3 | 1 | 0.7 | 80 |
| | | (HPPP) | | | | | |

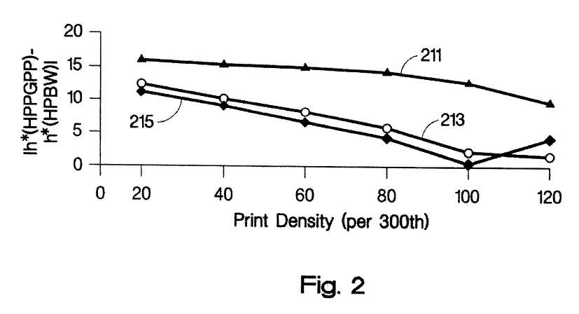

As illustrated in Table 4, the hue angle difference between an additive-containing ink printed on swellable media and the same ink printed on plain paper media is usually substantially less than the control ink hue angle difference.
Furthermore, in FIG. 2, a graph showing the hue angle difference of inks 157 and 158 of Table 4 is shown at increasing print fill densities. The X axis measures Print Fill Density (per 300^{th}) and the Y axis measures |h*(HPPGPP)−h*(HPBW)|, the |h*−h*| being the absolute value of the difference between the h* of two plain paper mediums. Two different |h*−h*| plots were achieved from two different concentrations of triethanolamine additive. The graph showing plots of |h*−h*| with triethanolamine (5%) and triethanolamine (2.5%) over a range of print fill densities was shown with plot (215) and plot (213) respectively. These plots were compared to the plot (211) formed of |h*−h*| control with no triethanolamine additive. It can be seen from FIG. 2, that the additive-containing inks 157 and 158 consistently produce lower hue angle differences than the control ink without additive over various print fill densities. In fact, the absolute value of the difference between the hue angle difference of the additive-containing ink printed on the two plain paper mediums in comparison to the hue angle difference of the control ink printed on the two plain papers increased as the print fill density of the inks increased.

### Example V

Two ink additives affecting hue angle of a colorant were admixed with several different inks, each having a colorant in an ink vehicle. The colorant used in this example is C485. The specific additive and colorant used for each ink were tabulated in Table 5. Each numbered ink was printed on two plain print media (HPBW and HPPP) in both its additive-containing state and its control state. The hue angle difference (h*) between the two plain paper print media for both the additive-containing ink and the control ink printed on both media were determined for a given ink and at a given print fill density. Furthermore, the absolute value difference between the two h* differences, additive-containing and control, for each ink was calculated, again at a given print fill density. The result for each numbered ink in terms of absolute value of hue angle difference and print fill density were compared in Table 5.

TABLE 5
Absolute value of difference in hue angle between two different plain papers
(HPBW and HPPP)

| | | | | h* | h* diff | h* diff (Cont) − h* | Print |
|---|---|---|---|---|---|---|---|
| Ink | Dye | Media | Additive | diff | (Cont) | diff | Density |
| 211 | C485 | h* (HPBW)- | Na | 4.6 | 6.1 | 1.5 | 80 |
| | | h* (HPPP) | acetate | | | | |
| 212 | C485 | h* (HPBW)- | NaH2PO4 | 4.6 | 6.1 | 1.5 | 100 |
| | | h* (HPPP) | | | | | |

As illustrated in Table 5, the hue angle difference between an additive-containing ink printed on one plain paper media and the same ink printed on another plain paper media is substantially less than the control ink hue angle difference.

### Example VI

Various ink additives affecting the chroma of a colorant were admixed with several different inks, each having a colorant in an ink vehicle. The colorants used in this example are K1334 and K820. The specific additive and colorant used for each ink were tabulated in Table 6. Each numbered ink was printed on porous media (EPGPP) and plain print media (HPPP) in both its additive-containing state and its control state. The chroma difference (c*) between the porous and plain paper print media for both the additive-containing ink and the control ink printed on both media were determined for a given ink and at a given print fill density. Furthermore, the absolute value difference between the two c* differences, additive-containing and control, for each ink was calculated, again at a given print fill density. The result for each numbered ink in terms of absolute value of chroma difference and print fill density were compared with all the other inks tested below in Table 6.

TABLE 6
Absolute value of difference in chroma between porous media (EPGPP) and
plain paper media (HPPP).

| | | | | | | c* diff | |
|---|---|---|---|---|---|---|---|
| | | | | | | (cont) − c* | |
| | | | | | c* diff | diff | Print |
| Ink | Dye | Media | Additive | c* diff | (cont) | (addit) | Density |
| 213 | K1334 | c* (EPGPP)- | Butyric acid | 0.4 | 3.6 | 3.2 | 20 |
| | | c* (HPPP) | | | | | |
| 214 | K1334 | c* (EPGPP)- | Succinic acid | 4.4 | 7.7 | 3.3 | 40 |
| | | c* (HPPP) | | | | | |
| 215 | K820 | c* (EPGPP)- | Na gluconate | 7.7 | 8.6 | 0.9 | 60 |
| | | c* (HPPP) | (20% 2- | | | | |
| | | | pyrrolidinone) | | | | |
| 216 | K820 | c* (EPGPP)- | NaCl | 2.9 | 8.4 | 5.5 | 80 |
| | | c* (HPPP) | | | | | |
| 217 | K820 | c* (EPGPP)- | Na methane | 5.4 | 6.8 | 1.4 | 100 |
| | | c* (HPPP) | sulfonate | | | | |
| 218 | K820 | c* (HPPGPP)- | NaCl | 4.6 | 6 | 1.4 | 80 |
| | | c* (HPPP) | | | | | |
| 219 | K820 | c* (HPPGPP)- | Na succinate | 5.7 | 7.2 | 1.5 | 60 |
| | | c* (HPPP) | | | | | |
| 220 | K820 | c* (HPPGPP)- | NaNO3 | 2.6 | 4.5 | 1.9 | 120 |
| | | c* (EPGPP) | | | | | |
| 221 | K820 | c* (HPPGPP)- | Na methane | 0 | 2.4 | 2.4 | 80 |
| | | c* (EPGPP) | sulfonate | | | | |

As illustrated in Table 6, the chroma difference between an additive-containing ink printed on one porous media and the same ink printed on plain paper media is substantially less than the control ink chroma difference.

What is claimed is:

1. An ink composition, comprising:
an ink vehicle;
a colorant; and
an additive effective to improve media independence of hue and chroma produced with said colorant.

2. An ink of claim 1 wherein the improvement of hue is at least 1.

3. An ink of claim 1 wherein the improvement of chroma is at least 1.

4. The ink composition of claim 1, wherein said colorant comprises a black colorant

5. The ink composition of claim 1, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

6. The ink composition of claim 4, wherein said additive is effective to improve media independence of hue and chroma produced by said black colorant on both swellable and porous print media.

7. The ink composition of claim 4, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

8. The ink composition of claim 4, wherein said black colorant comprises a black dye.

9. The ink composition of claim 1, wherein said colorant comprises a magenta colorant.

10. The ink composition of claim 9, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

11. The ink composition of claim 1, wherein said colorant comprises a cyan colorant.

12. The ink composition of claim 11, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

13. The ink composition of claim 11, wherein the additive comprises at least one of glycine, urea, 3-pyridylcarbinol, tris buffer, potassium dihydrogenphosphate, sodium triethanolamine, imidazole, and sodium benzoate

14. The ink composition of claim 1, wherein said hue on porous and swellable media differs by less than 5.

15. The ink composition of claim 14, wherein said chroma on porous and swellable media differs by less than 20.

16. The ink composition of claim 1, wherein the additive is present in the ink composition in an amount of between about 0.1% and about 10%.

17. The ink composition of claim 1, wherein the ink composition has a conductivity change of between about 5 mS/cm and about 60 mS/cm over that of an ink composition without the additive.

18. The ink composition of claim 1, wherein the ink additive is selected from the group consisting of an amine, an organic salt, an inorganic salt, a compound capable of generating an amine, a compound capable of forming a salt, a monovalent salt and any combination thereof.

19. The ink composition of claim 1, wherein the additive for controlling the color produced by the colorant on the print medium is selected from the group consisting of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

20. A method of making an ink composition, the method comprising adding an additive to a mixture of a colorant and an ink vehicle where said additive is effective to improve media independence of hue and chroma of a color produced by said colorant.

21. The method of claim 20, wherein said additive is present in said composition in a concentration of between about 0.1% and about 10%.

22. The method of claim 20, wherein said colorant comprises a black colorant

23. The method of claim 22, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

24. The method of claim 22, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

25. The method of claim 20, wherein said colorant comprises a magenta colorant.

26. The method of claim 25, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

27. The method of claim 20, wherein said colorant comprises a cyan colorant.

28. The method of claim 27, wherein the additive comprises at least one of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

29. The method of claim 27, wherein the additive comprises at least one of glycine, urea, 3-pyridylcarbinol, tris buffer, potassium dihydrogenphosphate, sodium triethanolamine, imidazole, and sodium benzoate

30. The method of claim 20, wherein said hue on porous and swellable media differs by less than 5.

31. The method of claim 20, wherein said chroma on porous and swellable media differs by less than 20.

32. The method of claim 20, wherein the ink composition has a conductivity change of between about 5 mS/cm and about 60 mS/cm over that of an ink composition without the additive.

33. The method of claim 20, wherein the ink additive is selected from the group consisting of an amine, an organic salt, an inorganic salt, a compound capable of generating an amine, a compound capable of forming a salt, a monovalent salt and any combination thereof.

34. The method of claim 20, wherein the additive for controlling the color produced by the colorant on the print medium is selected from the group consisting of amines, including aliphatic, aromatic, primary, secondary, tertiary, and amine oxides; a proton sponge (1,8-bis-[dimethylamino]naphthalene); MES buffer; LiNO3; 4,5-dihydroxy-1,3-benzenesulfonic acid; hexanoic acid; 2-hydroxyethylpiperidine; sodium succinate; KH2PO4;gluconic acid; urea; DL-threonine; caprolactam; triethanolamine; diethanolamine; trizma buffer (Tris); 2,6-dimethylaminopyridine (DMAP); 3-pyridylcarbinol; N-methyl-1,3-propanediamine; EDTA; piperidine; piperazine; pyridine- N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-l-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1- naphthol-3-sulfonic acid; 6-amino-4-hydroxy-2-naphthalenesulfonic acid; glucoheptonic acid; lactobionic acid; mucic acid; sodium chloride; potassium chloride; succinic acid; butyric acid; sodium methanesulfonate; sodium gluconate; calcium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

35. An ink composition, comprising:
an ink vehicle;
a colorant; and
an additive effective to increase neutrality of black or gray color produced by the colorant on at least one print medium.

36. The ink composition of claim 35, wherein said additive is further effective to increase neutrality of said color produced by said colorant on two or more different print media.

37. The ink composition of claim 35, wherein the ink additive is selected from the group consisting of an amine, an organic salt, an inorganic salt, a compound capable of generating an amine, a compound capable of forming a salt, a monovalent salt and any combination thereof.
